(19) United States
(12) Patent Application Publication
(10) Pub. No.: US 2012/0095825 A1
(43) Pub. Date: Apr. 19, 2012

(54) Incentive Selection of Region-of-Interest and Advertisements for Image Advertising

(75) Inventors: Tao Mei, Beijing (CN); Xian-Sheng Hua, Beijing (CN); Shipeng Li, Palo Alto, CA (US)

(73) Assignee: Microsoft Corporation, Redmond, WA (US)

(21) Appl. No.: 12/906,899

(22) Filed: Oct. 18, 2010

(51) Int. Cl. G06Q 30/00

(52) U.S. Cl. 705/14.43; 705/14.44

(57) ABSTRACT

Techniques for image selection and region of interest analysis are described herein. A pair of two or more users is configured, and an image is displayed to the pair. The image can be a still image (i.e., a picture) or a moving image (i.e., video). In some instances, a plurality of advertisements is suggested for possible association with the image. Input is received from both users in the pair, indicating a positive or a negative association between each advertisement and the image. When the pair positively rates an advertisement, the advertisement is associated with the image. A plurality of regions of interest within the image may be suggested. In response, positive or negative input is received from the pair indicating whether each of the plurality of regions of interest is appropriately suggested for placement of an advertisement.

### BACKGROUND

Traditional advertising may provide images or video of a product with a background of accompanying images or video. Newer advertising may provide “product placement” directly into video and still images provided to a consumer as entertainment. In both types of advertising, a question arises as to the most advantageous images and/or video into which to place images of the product, advertisement and/or logo of a corporate sponsor. Selection of an advantageous image or video could enhance the success of such advertisements, while a poorly selected image or video could render the advertisements useless. Unfortunately, little is known about how to select an image or video that is appropriate for use with a product, advertisement or corporate logo. Moreover, even less is known about how to categorize large numbers of such images or videos to indicate whether they are appropriate for use with known products, advertisements or corporate logos.

Moreover, the precise location at which to advantageously place a product, advertisement or logo within an image or video is not well understood. If the placement is selected correctly, a viewer's attention will be drawn to the product, advertisement or corporate logo. However, if the placement is selected incorrectly, the viewer may not notice the advertisement because other aspects of the image or video absorb the viewer's attention. Because each image and each video is potentially unique, and because large numbers of products, advertisements and corporate loges exist, new technology to locate advertisements within images and video would be welcome.

### SUMMARY

Techniques for selecting an advertisement (e.g., a corporate logo) due to its positive association with an image and for identifying regions of interest within the image are described herein. A pair of users is configured, and an image is displayed to the pair. The pair of users may be randomly combined visitors to a same website in some instances. The image can be a still image (i.e., a picture) or a moving image (i.e., video). In some instances, a plurality of advertisements is suggested for possible association with the image. Input is received from both users in the pair. The input can indicate a positive or a negative association between each advertisement and the image. When input from both users is positive with respect to an advertisement, the advertisement may be associated with the image. A plurality of potential regions of interest within the image may be suggested to the pair. In response, positive or negative input is received from each user in the pair indicating whether each of the plurality of regions of interest is appropriately suggested. When the pair agrees that a region of interest (ROI) was appropriately suggested, the image can be annotated to indicate the region of interest.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a diagram illustrating example techniques by which one or more advertisements may be evaluated for relevance with respect to an image. In the example techniques, a pair of users is configured to provide positive or negative input indicating whether each of the one or more advertisements is relevant with respect to the image.

FIG. 2 is a diagram illustrating a further example of techniques by which input from the pair of users may be utilized. In this example, the pair of users provides input used to confirm or deny the appropriateness of suggested regions of interest within an image for the location of an advertisement.

FIG. 3 is a diagram illustrating a still further example of techniques by which input from the pair of users may be utilized. In this example, the pair of users provides input used to confirm or deny the appropriateness of suggested regions of interest within a video for the location of an advertisement.

FIG. 4 is a diagram illustrating an example of a system configured to associate one or more advertisements with an image, to select an image for association with an advertisement of interest and to analyze regions of interest within an image.

FIG. 5 is a diagram illustrating additional detail of the system of FIG. 4. In particular, FIG. 5 shows images before, during and after processing with input from the pair of users, including associations with different advertisements and/or regions of interest.

FIG. 6 is a flow diagram illustrating example techniques by which advertisements are associated with images, and by which an image may be discovered that positively associates with an advertisement of interest.

FIG. 7 is a flow diagram providing additional detail to aspects of FIG. 6, in particular illustrating example techniques by which images are selected for display to paired users, and by which advertisement are selected for possible association with selected images.

FIG. 8 is a diagram supporting the discussion of FIG. 7, and particularly illustrating example techniques by which a location within an image may be selected for insertion of an advertisement.

FIG. 9 is a flow diagram illustrating example technology by which regions of interest are selected within an image.

FIG. 10 is a flow diagram providing additional detail to aspects of FIG. 9, in particular illustrating example techniques by which one or more regions of interest are suggested.

FIG. 11 is a flow diagram providing additional detail to aspects of FIG. 9, in particular illustrating saliency map generation, extraction of attended areas, and the supplementation of attended areas with facial recognition technology.

### DETAILED DESCRIPTION

The disclosure describes techniques for selecting one or more advertisements (e.g., corporate logos) due to their positive association with an image. Thus, an image may be paired with certain advertisements with which it is compatible. By extension, an image may be found and paired with an advertisement of interest. Additionally, techniques are described for identifying regions of interest within an image.

A pair of users may be configured and an image is displayed to the pair. The pair of users may be randomly combined visitors to a same website. The image can be a still image (i.e., a picture) or a moving image (i.e., video). In some instances, a plurality of advertisements is suggested for possible association with the image. Input is received from the pair, wherein each user indicates a positive or a negative association between each advertisement and the image. When the pair agrees that an advertisement is appropriately associated with the image, the pair may be rewarded and the advertisement and image may be associated in metadata or an appropriate data structure.

A plurality of potential regions of interest within the image may be suggested to the pair. In response, positive or negative input is received from the pair indicating whether each of the plurality of regions of interest is appropriately suggested for location of an advertisement. When the pair agrees that a region of interest was appropriately suggested, the image can be annotated (such as in metadata) to indicate the region of interest.

The discussion herein includes several sections. Each section is intended to be non-limiting. Additionally, this entire description is intended to illustrate components which may be utilized in image and advertisement association, and utilized in region of interest analysis, but not components which are necessarily required. The discussion begins with a section entitled “Example Image Selection and Region of Interest Analysis,” which describes techniques by which advertising and images and/or videos may be assessed for relevance and possible association, and how regions of interest may be located in images. Next, a section entitled “Example Architecture” illustrates and describes a high-level architecture of a system configured for image selection and region of interest analysis. A section, entitled “Example Image Relevance in Advertising Context” illustrates and describes techniques, systems and methods by which one or more advertisements may be evaluated for association with one or more images (or the reverse), and by which an image may be found for association with an advertisement of interest. A section, entitled “Example Region of Interest Analysis” illustrates and describes techniques, systems and methods by which proposed regions of interest within images may be evaluated. Finally, the discussion ends with a brief conclusion.

Throughout this discussion, images and images files are largely discussed in a unified manner; i.e., a discussion of “an image” or “a video” implies a discussion of the data and/or data files upon which such images are based. Additionally, use of the terminology “an image” can be indicative of a still image (e.g., a picture) or a motion image (e.g., a video). This brief introduction, including section titles and corresponding summaries, is provided for the reader's convenience and is not intended to limit the scope of the claims, nor the proceeding sections.

### Example Image Selection and Region of Interest Analysis

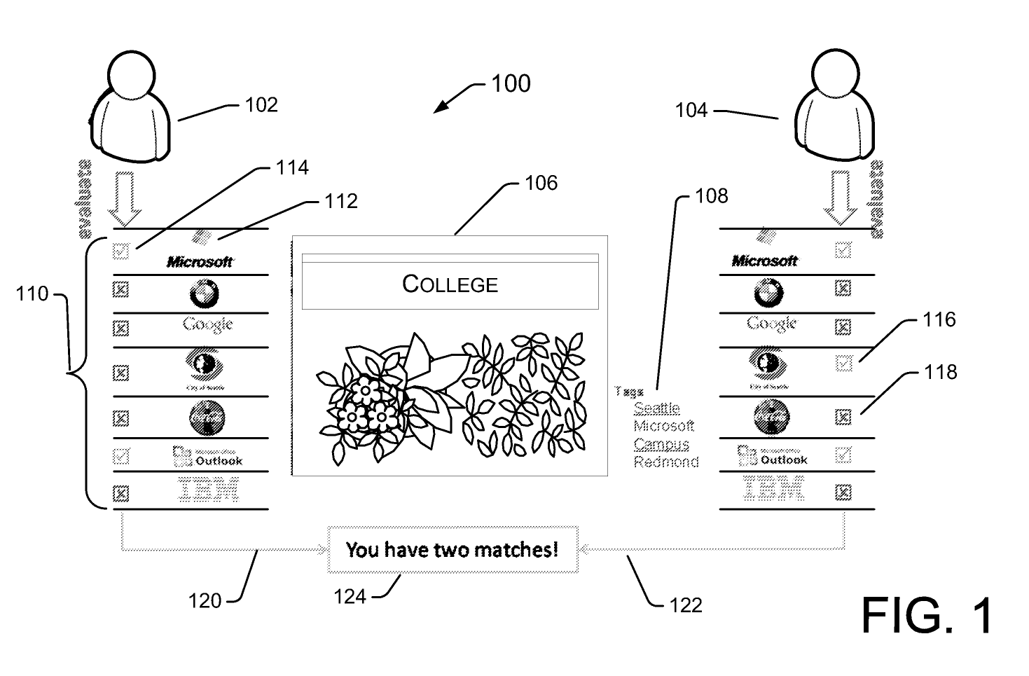

FIG. 1 is a diagram 100 illustrating example techniques by which an image (e.g., still image, video, etc.) may be evaluated for relevance with respect to one or more advertisements. By extension, the diagram 100 illustrates a potentially iterative process by which a sequence of images could be processed and an image discovered that positively associates with an advertisement of interest. Moreover, the diagram 100 is intended to be illustrative of more general concepts, and does not present required features, aspects or techniques. For example, while FIG. 1 is presented in terms of a still image, it is also applicable to video and other types of visual content or “images”. That is, the example techniques of FIG. 1 show how one or more advertisements (e.g., logos or other advertisements) may be evaluated for relevance with respect to a video.

In one example, a first user or player 102 and a second user or player 104 are configured as a pair. The configuration includes associating the users so that their output can be compared and jointly processed. By pairing two users, two sources of input are obtained for each issue and/or question. When input from two sources agree—such as when both user in a pair of users answer a question positively—the input may be associated with an enhanced or desired level of veracity or validity. Further, while the following examples, describe the pairing of two users, other implementations may pair together any other number of users (e.g., one, three, ten, one hundred, etc.). Thus, for purposes of this document, a “pair” should be interpreted as a grouping of any number of users. A single user or player may be “paired” with a composite of past users, and input from the single user compared against a composite of past users' responses.

The users 102, 104 are presented with an image 106. The image may be associated with one or more tags 108 or other metadata. The users 102, 104 are also presented with a list or plurality 110 of advertisements 112. In the example of FIG. 1, the advertisements include corporate logos. However, the advertisements may be any type of image, video, audio and/or audio/video track or clip. Each advertisement 112 may be associated with an input box 114 or other user interface device, which allows the user to provide positive input or negative input. Box 116 shows an example of positive input, wherein the box includes a checkmark. Box 118 shows an example of negative input, wherein the box includes an “X.” Those familiar with user interfaces will easily envision other ways to manage user input to achieve a similar result.

In operation, the two users 102, 104 are invited to express an opinion as to the relevance of the image 106 to the advertisements 112 in the plurality 110 of advertisements. Thus, each user 102, 104 will review the image 106 and the plurality of advertisements 110, and to positively or negatively respond to each advertisement. In the example of FIG. 1, the user 102 has responded positively to two advertisements. The positive responses indicate that the user feels that the image 106 is relevant to those two advertisements and/or that the user feels that the two advertisements are relevant to the image 106. In contrast, the user 104 has responded positively to three advertisements—including the two advertisements to which the user 102 responded positively—and also a third advertisement.

Accordingly, there is input 120 from the first user 102 and input 122 from the second user 104. In the example of FIG. 1, the positive input given by each user is considered, to determine if corresponding input from the other user is also positive. For example, both users indicated a positive checkmark regarding the “Microsoft® logo.” Accordingly, this resulted in a match. Both users indicated a negative checkmark regarding the “BMW logo,” indicating that neither user felt the image was associated with, or suggestive of, BMW. While this could be considered “a match,” in the embodiment of FIG. 1 it is not. This is because the goal is to find images that are associated with advertisements (or the reverse). Accordingly, the users are given feedback 124, indicating that they have two matches. That is, they both gave positive input to a same two of the advertisements (i.e., corporate logos), including the “Microsoft® logo” and the “Microsoft® Office Outlook logo.” Accordingly, there is a commonly selected advertisement. The feedback 124 may be provided according to a user interface, typically having a graphical user interface nature and appearance.

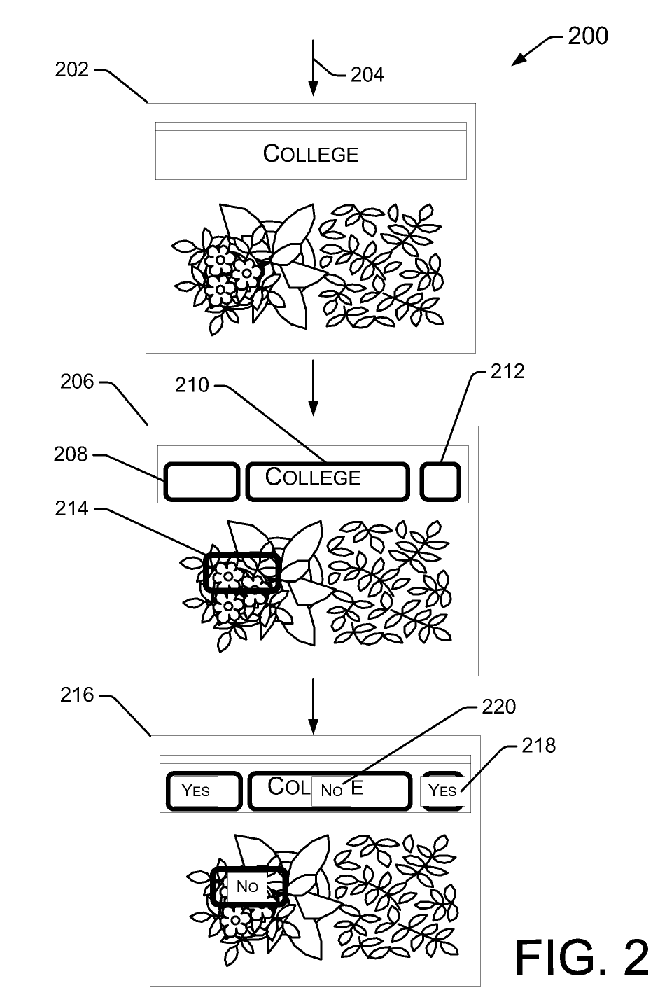

FIG. 2 is a diagram 200 illustrating a further example of techniques by which input from the paired users may be utilized. In this example, paired users provide input used to confirm or deny the appropriateness of suggested regions of interest within an image. In one aspect, FIG. 2 illustrates that the techniques disclosed herein are able to distinguish generalized regions of interest within an image (e.g., photo or video) with those regions of interest that are well suited for placement of an advertisement, such as a corporate logo. Intuitively, regions of interest are locations to which a viewer's eye is drawn. However, some such regions of interest may be inappropriate for use in locating an advertisement. For example, a person's face may be a region of interest, but is an inappropriate location for an advertisement. Accordingly, FIG. 2 illustrates techniques by which preferred advertising locations may be selected from among regions of interest.

FIG. 2 shows input and output from one of the two users 102, 104 (seen in FIG. 1). In particular, each of the users independently provides input suggesting which of the suggested regions of interest the user believes are of interest to that user and/or which of the suggested regions of interest were appropriately suggested. The other user would perform a similar evaluation. Positive results from the users that are in agreement (i.e., both users agree that a suggested region of interest is appropriately suggested) may result in a confirmation that the suggested region of interest was appropriately suggested. This may result in some annotation to the image and/or its metadata.

The image 202 may be obtained at 204 from FIG. 1, after the image was evaluated for relevance with respect to the advertisements 110 (as seen in FIG. 1). Alternatively, the image 202 may be obtained at 204 from a library of images, a website or other source of images.

The image 202 is processed to include one or more suggested regions of interest. In the example of FIG. 2, processing of image 202 results in image 206, having suggested regions of interest 208-214. A copy of the image 206 is provided to each of the users (e.g., users 102, 104 of FIG. 1) for annotation.

An example of a user-annotated image 216 is seen in FIG. 2. The example user-annotated image 216 includes two suggested regions of interest wherein a “yes” 218 or other positive indication has been applied by the user. Such positive input indicates that the user agrees that the suggested region of interest is appropriate for placement of an advertisement. Where both users give positive input regarding a particular region of interest, then that region of interest is a commonly selected region of interest. The example user-annotated image 216 also includes two suggested regions of interest wherein a “no” 220 or other negative indication has been applied by the user. Such negative input indicates that the user disagrees that the suggested region of interest is appropriate for placement of an advertisement.

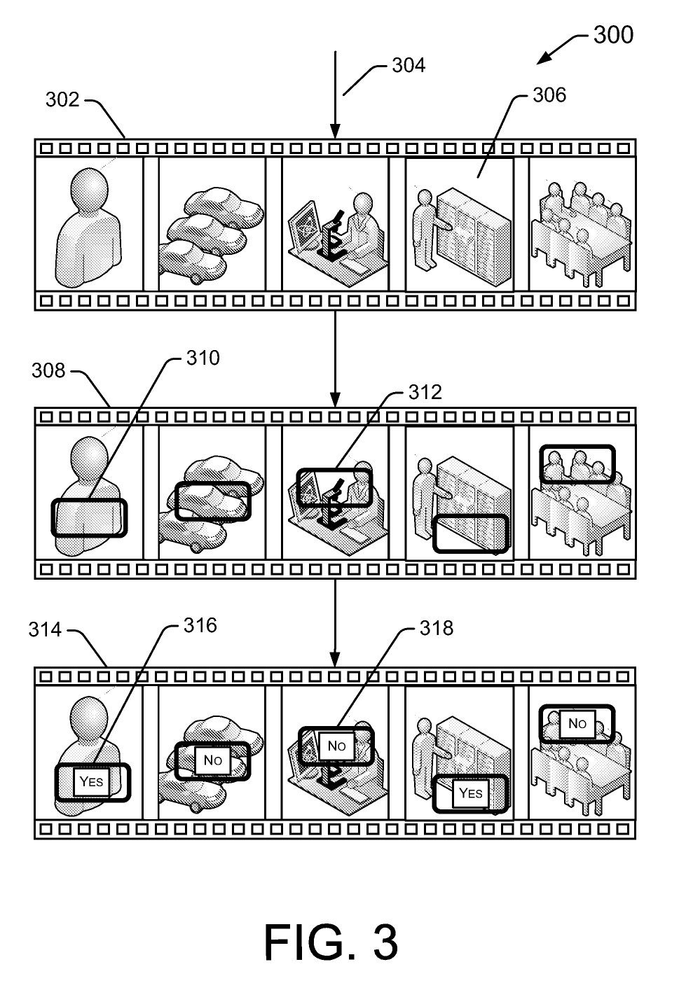

FIG. 3 is a diagram 300 illustrating a still further example of techniques by which input from the paired users may be utilized. In this example, paired users provide input used to confirm or deny the appropriateness of suggested regions of interest within video. Accordingly, FIG. 3 is similar to FIG. 2, but differs at least in that FIG. 3 relates to moving images (e.g., “video”) while FIG. 2 relates to still images (e.g., images or “pictures”).

Thus, FIG. 3 shows user evaluation of suggested regions of interest in video to determine if they represent appropriate locations for placement of an advertisement. The evaluation indicates which of the suggested regions of interest the user believes are appropriate for an advertisement, or which of the suggested regions of interest were appropriately suggested. The other user would perform a similar evaluation. Positive results from the users that are in agreement (e.g., both users agree that a particular suggested region of interest is appropriately suggested as a location for an advertisement) may result in a confirmation that the suggested region of interest is appropriate for placement of an advertisement. This may result in appropriate annotation to the image and/or its metadata.

The video 302 may be obtained at 304 from FIG. 1, after the video was evaluated for relevance with respect to the advertisements 110 (as seen in FIG. 1). Alternatively, the video 302 may be obtained at 304 from a library including videos, a website or other source of video. The video 302 will typically have a number of “frames,” 306 images or “views” that comprise the video. Thus, while FIG. 3 shows five such “frames,” they are representative of additional frames, as needed, to provide a motion picture and/or “video.”

The video 302 is processed to include one or more suggested regions of interest. In the example of FIG. 3, processing of video 302 results in video 308, having suggested regions of interest 310, 312 and others. The video 308 is provided to both users (e.g., users 102, 104 of FIG. 1) for annotation.

An example of a user-annotated image 314 is seen in FIG. 3, having suggested regions of interest wherein a “yes” 316 or other positive indication has been applied by the user, thereby indicating that the user agrees that the suggested region of interest is appropriate for placement of an advertisement. The example annotated image 314 also includes suggested regions of interest wherein a “no” 318 or other negative indication has been applied by the user, thereby indicating that the user disagrees that the suggested region of interest is appropriate for placement of an advertisement.

### Example Architecture

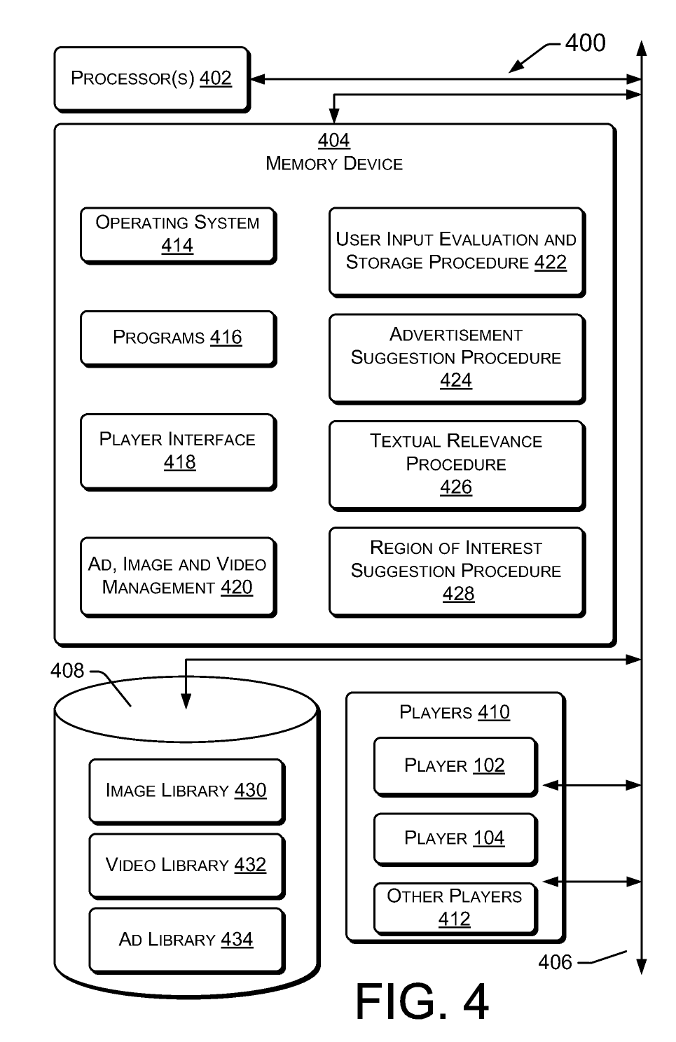

FIG. 4 is a diagram illustrating an example of a system 400 configured to associate one or more advertisements with an image, to select an image for association with an advertisement of interest, and/or to analyze regions of interest within an image. The system 400 shows one example of how image and/or advertisement selection, and region of interest analysis, could be performed. However, the arrangement and configuration of software data, programs, objects, etc., is largely flexible, and other configurations could be conceived that are within the scope of the techniques disclosed herein.

A processor 402 (e.g., a microprocessor, controller, CPU or similar device) is in communication with a memory device 404 over a bus 406 or other communications pathway. An additional memory device 408 may be configured for containment of a large number of files, such as images, videos and/or advertisements. A plurality of players 410, may include the players 102, 104 of FIG. 1 and other players 412, across a network, such as an intranet, the Internet and/or other network(s). Thus in certain embodiments of the system 400, the bus 406 is representative of communication means generally, and can additionally include networks and the Internet.

The memory device 404 may include a number of software data structures, programs and objects, etc. While memory device 404 is described as a memory device, all or part of device 404 could be implemented as a processing device, such as an application specific integrated circuit (ASIC). Accordingly, while it is convenient to refer to device 404 as being a memory device, other technologies could give functionally similar results, and are within the scope of this disclosure. An operating system 414 may handle traditional OS functionality, plus any enhancements required for a particular system. One or more programs 416 may reside in the memory 404. A player interface 418 communicates with players 410 and may provide a graphical user interface and associated input and output communications. An advertisement, image and video management program 420 may be used to manage an image library 430, a video library 432 and an advertisement library 434, which may be contained on the memory or disk 408.

The system 400 may include a user input evaluation and storage procedure 422 to evaluate and store the input of the users and/or players 410. An advertisement suggestion procedure 424 may be provided, and may be operable to suggest the advertisements for consideration by paired users (e.g., advertisements 110 considered by users 102, 104, as seen in FIG. 1). A textual relevance procedure 426 may be provided to assist in the suggestion of advertisements. A region of interest suggestion procedure 428 may be provided to suggest the regions of interest in images and videos, such as is indicated by FIGS. 2 and 3.

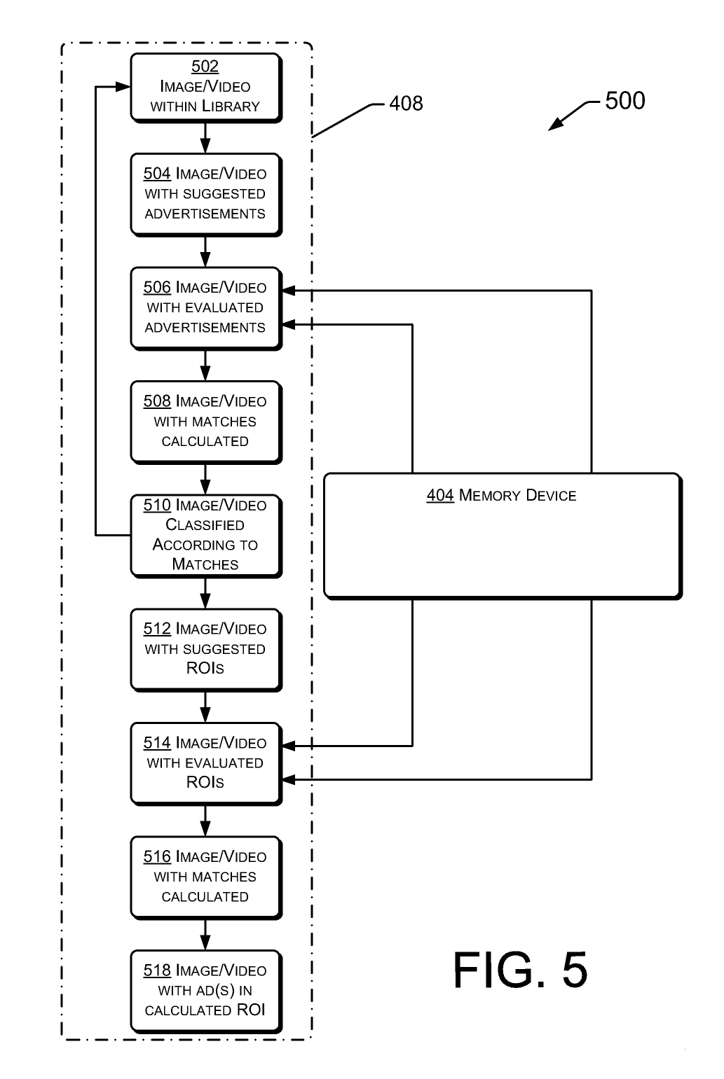

FIG. 5 is a diagram 500 illustrating optional aspects of image files and techniques described with respect to FIG. 4. In particular, the diagram 500 shows image files in different states, and images in association with different advertisements and/or regions of interest. Additionally, techniques by which software within the memory device 404 operates on the images are discussed. In a general sense, the image files discussed in diagram 500 may be managed in memory by the advertisement, image and video management procedure 420 of FIG. 4, or similar hardware and/or software procedure.

An image 502 may be identified from within a library. Referring to FIG. 4, such an image may be obtained from an image library 430 or a video library 432. Accordingly, the image 502 generalized in nature, and is therefore representative of images and videos. The image 106 (FIG. 1), prior to association with suggested advertisements 110, is representative of the image 502.

An image 504 may include suggested advertisements. The suggested advertisements may be provided by the advertisement suggestion procedure 424 of FIG. 4, or alternative hardware and/or software procedure. The suggested advertisements may be associated with the image by means of metadata, a database or other data structure. Because the advertisements are “suggested,” a strong association between the image 504 and advertisements associated with that image has not yet been established. In the example of FIG. 1, the image 106, prior to input from the users 102, 104 evaluating the association between the image and the advertisements 110, is representative of images 504 having selected advertisements.

An image 506 may include evaluated advertisements. The evaluation may include data associated with the image by means of metadata, database or other data structure. The evaluated advertisements may have been “evaluated” by receipt of opinions from users, such as users 102 and 104 of FIG. 1. In the course of evaluation, input from operation of programs or procedures resident in memory 404, such as player interface 418, may request and receive evaluations for association to the image 506. If the evaluation process is on-going (i.e., if opinions of more user are sought) then the suggested advertisements and the user evaluations may be simultaneously associated with the image 506.

An image 508 may include data (e.g., metadata) indicating the matches obtained by user input. Such matches—indicating that two or more users agreed that the advertisements and images are correctly associated—include greater weight and/or veracity than simple evaluation by a single user. Accordingly, an image 508 with associated match data is more useful in advertising projects, in that a positive association has been made between the image and the advertisement. In one example, the data obtained from user input can be managed by the user input evaluation and storage procedure 422 of FIG. 4, or by an alternative software or hardware procedure.

An image 510 may be classified as having match data associated with one or more advertisements. Such an image 510 may be of utility in advertisement for one or more corporations and/or products. In some implementations of the system 400 (of FIG. 4), the various libraries of 408 may be repeatedly accessed, such as in an effort to obtain an image appropriate to an advertisement of interest. For example, if an advertisement for Microsoft® is of interest, and the image 510 is not classified as a match to the Microsoft® advertisement, another image 502 may be selected in an iterative manner. The iteration may continue until an image 510 is found that is classified positively with respect to Microsoft® advertisements.

An image 512 may be classified according to a desired advertisement. However, because a correct position within the image for an advertisement has not been determined, the image 512 may include or be associated with data (e.g., metadata) indicating suggested regions of interest (i.e., locations at which an advertisement may be placed). Images 206 (FIG. 2) and 308 (FIG. 3) are specific examples of a general class of images 512 having suggested regions of interest. The suggested regions of interest may be obtained from the region of interest suggestion procedure 428, or by an alternative software or hardware procedure.

An image 514 may include evaluated regions of interest. The evaluation may include data associated with the image by means of metadata, database or other data structure. The evaluated regions of interest may have been “evaluated” by receipt of opinions from users. Accordingly, images 216 (still pictures, FIG. 2) and 314 (video, FIG. 3) are specific examples of the generalized image 514 having evaluated regions of interest. In the course of evaluation, input from operation of programs or procedures resident in memory 404 may request and receive evaluations for association to the image 506. If the evaluation process is on-going (i.e., if opinions of more users is sought) then the suggested regions of interest and the user evaluations may be simultaneously associated with the image 514.

An image 516 may include data (e.g., metadata) indicating the matches obtained by user input. Such matches—indicating that two or more users agreed that the region(s) of interest within the image were correctly placed—include greater weight and/or veracity than simple evaluation by a single user. Accordingly, an image 516 with associated match data is more useful in advertising projects, in that regions of interest within the image have been identified.

An image 518 may include data (e.g., metadata) indicating (by calculated user matches) a positive association with one or more advertisers and/or advertisements and (also by calculated user matches) confirmed regions of interest. Accordingly, image 518 may have an advertisement—to which it was positively associated by matching user input—located in a region of interest, which is positively confirmed by matching user input.

### Example Image Relevance in Advertising Context

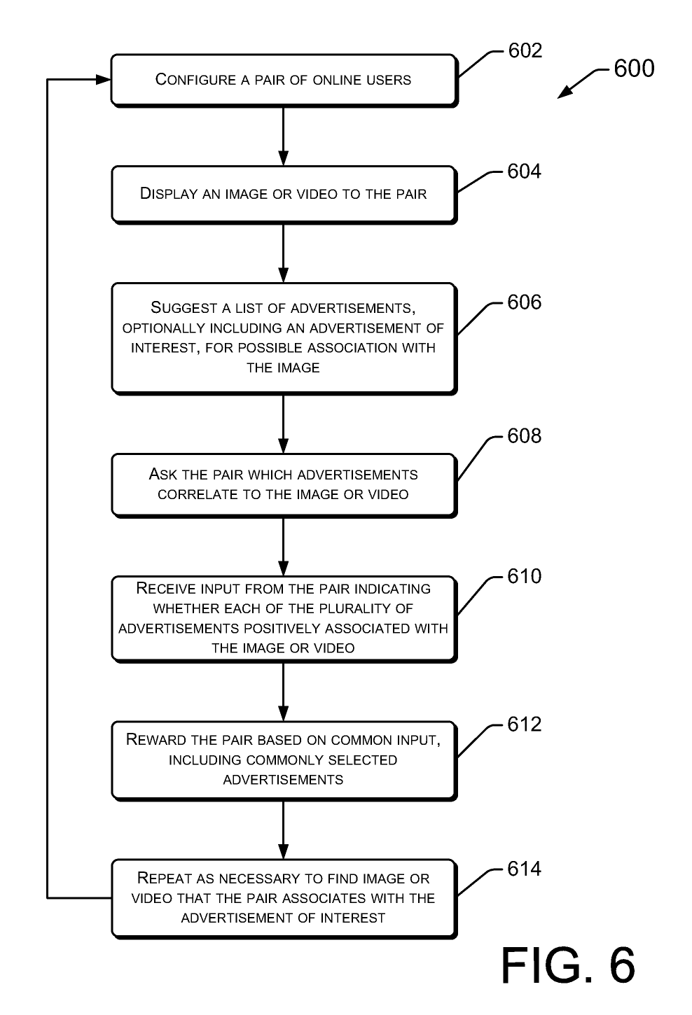

FIGS. 6, 7, 9 and 10 describe various processes in a manner illustrated by a collection of blocks in a logical flow graph, which represent a sequence of operations that can be implemented in hardware, firmware, software, or a combination thereof In the context of software, the blocks represent computer-executable instructions stored on one or more computer-readable storage media, memory devices, storage devices and/or memory storage device, that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. Accordingly, the blocks may involve storing, in a memory communicatively coupled to a processor, computer-executable instructions, executing the instructions on the processor, and then, according to the instructions being executed, performing the processes disclosed herein.

FIG. 6 is a flow diagram illustrating an example process 600 for selecting an advertiser and/or an advertisement that is positively associated with an image, and by which an image may be determined or obtained that positively associates with an advertisement of interest. In one example, the process 600 describes the operation of the system or computing device or system 400 of FIG. 4. Accordingly, the example process of FIG. 600 can be understood in part by reference the configuration of FIGS. 1-5. However, FIG. 6 contains general applicability, and is not limited by other drawing figures and/or prior discussion.

At block 602, a pair of two or more online users is configured. The pair can be configured from among users concurrently visiting a website. Therefore, the pair of users may be configured from two users located in distinct locations on a network, such as the Internet. Where only a single user is available, and a pair for that user is unavailable, the single user may be paired to a composite of past users. The composite of past users may be an average, typical or most common response of the past users. At block 604, an image is displayed to the pair of users. In the example of FIG. 1, the image 106 is displayed to the users 102, 104. The image 106 is representative of still images (pictures) and motion images (video). Such an image may be obtained from the image library 430 or video library 432 of FIG. 4, or other location wherein images are located.

At block 606, a plurality of advertisements is suggested to the pair of users. In the example of FIG. 1, the advertisements 110 are shown to users 102, 104. The advertisements may be of any type: video, audio, audio/video, still image, logo, trademark, etc. In some instances, one of the advertisements is an advertisement of interest, i.e., an advertisement for which an image having a positive association or correlation is sought.

At block 608, the pair of users is asked to “rate” the association and/or correlation between the image and each of the plurality of advertisements. This can be a positive or negative feedback. At block 610, input is received from the pair regarding correlation of each of the plurality of advertisements to the image or video. Positive feedback from both users in the pair can result in a positive association between an image and an advertisement. Accordingly, the advertisement is commonly selected for association with the image. In the example of FIG. 1, the users 102, 104 provide input regarding the correlation between the logos 110 and the image 106 by providing positive input (116 of FIG. 1) or negative input (118 of FIG. 1) to indicate positive or negative correlation between the image and the advertisements (i.e., the logos 110 of FIG. 1).

At block 612, the pair of users is rewarded for common input, and particularly for common positive input wherein the pair both selected an advertisement or logo as associating and/or correlating with the displayed image. In the example of FIG. 1, the pair of users 102, 104 is rewarded for two positive associations or correlations in common. In particular, both users positively correlated the image with the “Microsoft® logo” and the “Microsoft Office Outlook® logo.” The reward can include points, discounts on merchandise, coupons, credit or anything of perceived, financial or psychological value.

At block 614, the process of finding an image with a positive correlation and/or association to plural users (e.g., a pair of users) may be repeated as desired. Repetition may be desired to associate or correlate each of a group of images with one or more advertisements or advertisers, or to associate or correlate one or more advertisements with one or more images. In some instances, there may be an advertisement of interest for which an associated and/or correlated image is desired. In this example, the process 600 may be repeated until an appropriate image is discovered for the advertisement of interest.

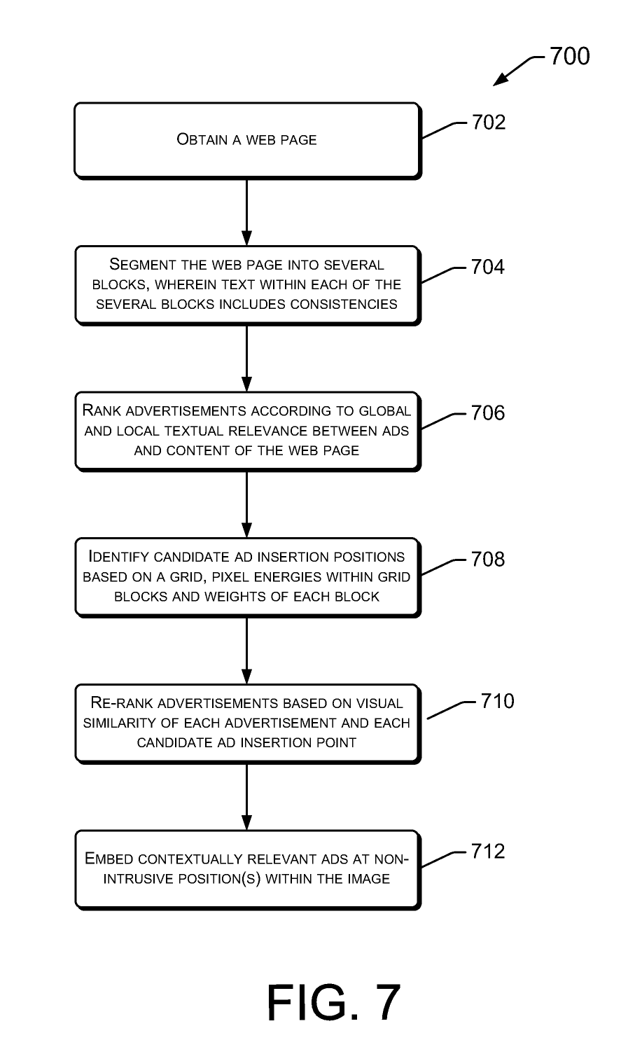

FIG. 7 is a flow diagram 700 providing additional detail to aspects of FIG. 6. In particular, at least blocks 604-606 of FIG. 6 are described in additional detail, thereby illustrating example techniques by which images are selected for display to paired users, and by which advertisements are selected for possible association with selected images.

At block 702, a user interface, such as a web page, is obtained. The web page or other user interface may be a source of images. At block 704, the web page (described here as the example user interface) is segmented into several blocks. The blocks are formed so that text in each block includes consistencies. The consistencies may be determined by any appropriate means, such as relevancy matching. For example, the textual relevance procedure 426 of FIG. 4 may be utilized. At block 706, advertisements are ranked according to global and local textual relevance between advertisements and content of the web page. At block 708, candidate advertisement insertion positions are identified. Insertion positions are locations within an image where an advertisement may be “inserted” or located. The candidate advertisement insertion positions may be identified in part based on an average of normalized energies of pixels within blocks of a grid superimposed over the image. Additionally, the insertion points may be identified in part on a weight applied to each block of the grid to emphasize ad insertion positions on sides and in corners of the grid. At block 710, the advertisements are re-ranked based on visual similarity of each advertisement and each candidate advertisement insertion point. At block 712, the contextually relevant ads are embedded into non-intrusive positions within the image.

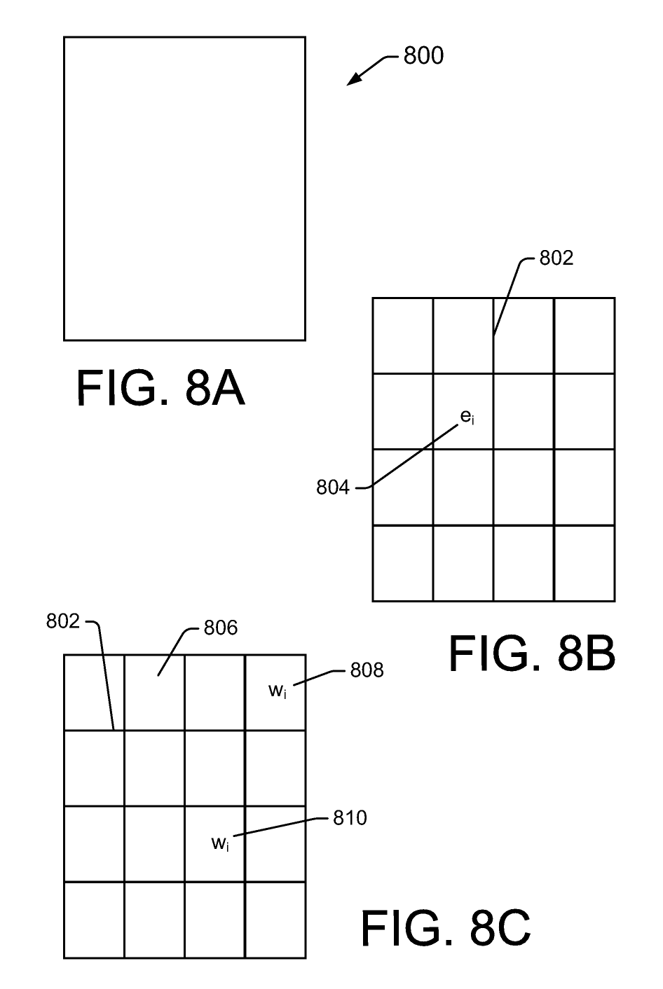

FIG. 8 shows an example by which insertion points may be identified, including locations within an image that may be selected for insertion of an advertisement. Accordingly, FIG. 8 is one example of the techniques of block 708 of FIG. 7. In one example, the insertion positions may be identified and/or calculated based in part on a grid, superimposed over the image, pixel energies of the pixels in the image and weights assigned to each block. In particular, FIG. 8A shows an image 800. At FIG. 8B, a grid 802 is superimposed over the image. Each pixel 804 of the image may include an energy term eᵢ. For example, a bright pixel in a saliency map is of high energy. The energy term may also be based in part on contrast within an area of the pixel. Intuitively, the energy term for each pixel indicates areas of interest within the image (such as a person's face) wherein an advertisement would be intrusive. Accordingly, the energy terms tend to push the advertisement insertion points away from more interesting areas of the image. Additionally, as seen in FIG. 8C, a weight factor can be assigned to each block 806 in the grid 802. For example, a higher weight factor can be assigned to blocks 808 in the corners and along the edges of the image, while a lower weight factor is assigned to blocks 810 in the central areas of the image. Thus, the weight factors tend to push the candidate advertisement insertion position to the edges and corners of the image, where they will be less intrusive.

### Example Region of Interest Analysis

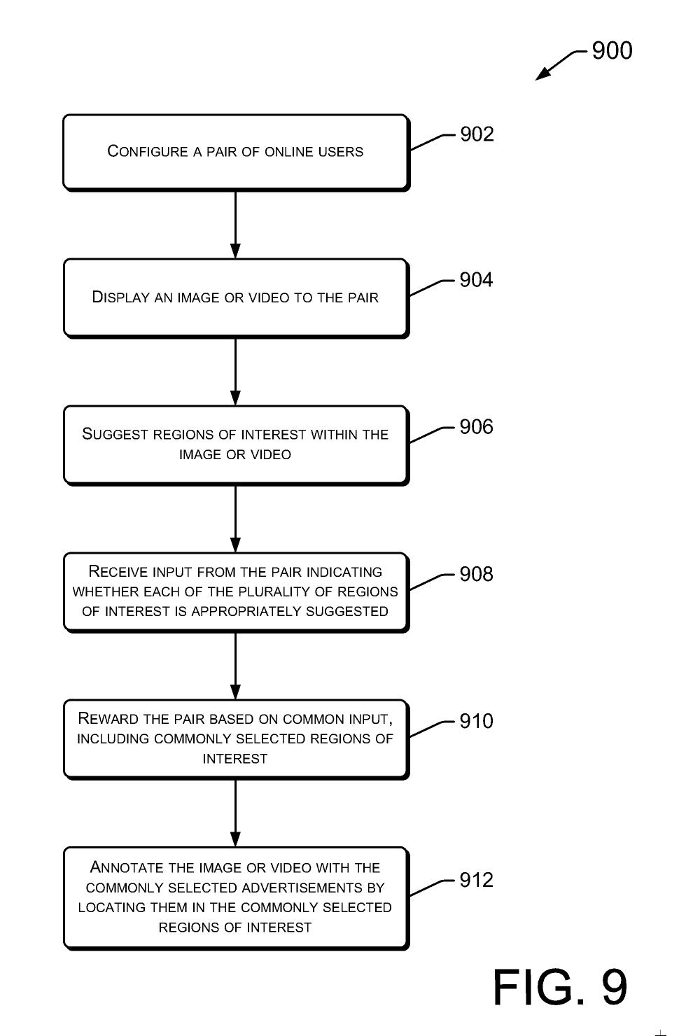

FIG. 9 is a flow diagram illustrating one possible implementation 900 by which regions of interest in images are selected as locations at which advertisements may advantageously be located. While a viewer's interest is drawn to regions of interest within an image, not all regions of interest (e.g., someone's face) are advantageous for advertisement placement. At block 902, a pair of online users is configured. This pair can be configured in the manner of users 102, 104 in FIG. 1, and can include any desired number of users. In some instances, where only one user is available, that user may be “paired with” a composite of the most common answers of prior users. At block 904, an image or video is displayed to the pair of matched users. An example of such an image is seen at 202 in FIG. 2 and such a video is seen at 302 in FIG. 3.

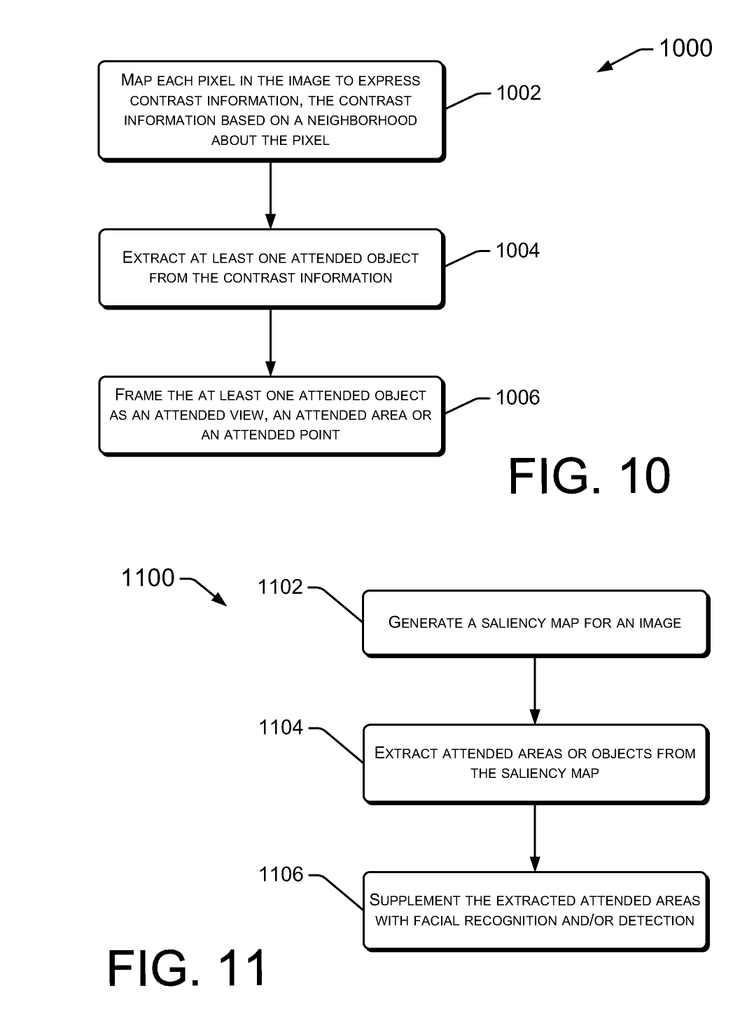

At block 906, regions of interest within the image or video are suggested to the pair of online users 102, 104. Referring to FIGS. 2 and 3, suggested regions of interest include 210-214 and 310-312. A discussion of how suggestion of such regions of interest are identified and then suggested is found in FIG. 10.

At block 908, input from the pair of users regarding the suggested regions of interest is received. The input will be positive or negative, such as the positive input 218, 316 (FIGS. 2 and 3) and the negative input 220, 318 (FIGS. 2 and 3). In particular, positive input indicates that a user agrees that a suggested region of interest within the image is appropriate for placement of an advertisement. Negative input indicates that the user feels that the suggested region of interest, while perhaps drawing the user's attention, is not advantageous for placement of an advertisement. At block 910, the pair of users is rewarded based on common input, such as regions of input wherein both users found that the region was of interest. Where the region of interest is positively indicated by both users, it is a commonly selected region of interest. The reward for the commonly selected region of interest is indicated at 124 in FIG. 1, and can be anything of value, such as a “thanks,” a coupon, credit, special offer or a monetary award.

At block 912, the image or video is associated with the commonly (both of the pair of users) selected advertisements by locating the advertisements in the commonly selected regions of interest. For example, where both users associated a particular advertisement with a particular image, that advertisement could be associated with the image and/or the image would be associated with the advertisement. Additionally, where both users selected a particular region of interest in the image, the region of interest could be associated with the image and the advertisement could be inserted into that region of interest.

FIG. 10 is a flow diagram 1000 providing additional detail to aspects of FIG. 9, in particular illustrating example techniques by which one or more regions of interest are suggested, such as at block 906 of FIG. 9. At block 1002, each pixel in the image is mapped to express contrast information. The contrast information may be based on a neighborhood about the pixel. For example, the contrast information may be based on C_{i,j}=Σ_{qεθ}d(p_{i,j}, q). In this expression, the C_{i,j} are contrast of pixels p_{i,j} normalized as [0, 255] in an M×N array of pixels representing the image, and points q are in a neighborhood θ about p_{i,j}. The size of θ can be used to regulate sensitivity of the contrast information, and d is a Gaussian distance function.

At block 1004, at least one attended object is extracted from the contrast information, i.e., from the C_{i,j}, which can represent contrast information accumulated from each pixel in the image. In one example, the extraction may be performed by converting gray-levels of the contrast information to define attended areas and unattended areas within the image.

At block 1006, at least one of the attended objects is framed as an attended view. The attended view may be at a center of attention of the image, an attended area or an attended point. Examples of a framed view include the suggested regions of interest are seen at 208-214 of FIGS. 2 and 310-312 of FIG. 3.

FIG. 11 is a flow diagram 1100 providing additional detail to aspects of FIG. 9, illustrating further alternative example techniques by which one or more regions of interest are suggested, such as at block 906. At block 1102, a saliency map is generated for an image. While FIG. 10 disclosed extracting an attended object from contrast information, contrast is only one channel for computing attention. Accordingly, generation of a saliency map should not be strictly associated with contrast, but should be more generally considered. At block 1104, attended areas or objects are extracted from the saliency map. At block 1106, the extracted areas are supplemented and/or modified with facial recognition and/or facial detection algorithm(s). Facial recognition software is becoming a mature technology, and is therefore both efficient and reliable in operation. Accordingly, facial rectangles may be advantageously used to identify and/or refine the attended areas or objects extracted from the saliency map. Moreover, attended areas may be supplemented with input derived from a facial recognition algorithm applied to the image. The attended areas or objects, optionally refined by facial recognition, may be regions of interest, or may be suggested as such to the pair of online users 102, 104 for their consideration.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more computer-readable media storing computer-executable instructions that, when executed, cause one or more processors to perform acts comprising:
configuring a pair of two or more users;
causing display of an image to at least one user of the pair of users;
suggesting a plurality of advertisements for possible association with the image;
receiving positive or negative input from each user of the pair of users indicating whether each of the plurality of advertisements positively associates with the image;
suggesting a plurality of regions of interest within the image; and
receiving positive or negative input from each user of the pair of users indicating whether each of the plurality of regions of interest is appropriately suggested.

2. One or more computer-readable media as recited in claim 1, wherein configuring the pair of users comprises pairing a new user to a composite of past users.

3. One or more computer-readable media as recited in claim 1, wherein receiving positive or negative input from each user of the pair of users indicating whether each of the plurality of regions of interest is appropriately suggested comprises receiving input indicating whether a suggested region of interest is appropriate for placement of an advertisement.

4. One or more computer-readable media as recited in claim 1, wherein causing display of the image to the at least one user of the pair of users comprises displaying the image as a moving image.

5. One or more computer-readable media as recited in claim 1, wherein causing display of the image to the at least one user of the pair of users comprises:
obtaining a web page;
segmenting the web page into multiple blocks, wherein the multiple blocks are formed in part by grouping text having consistencies; and
selecting the image from at least one of the multiple blocks.

6. One or more computer-readable media as recited in claim 1, wherein suggesting a plurality of advertisements comprises:
ranking advertisements according to global and local textual relevance between the advertisements and content of the web page;
identifying candidate advertisement insertion positions based at least in part on an average of normalized energies of pixels within blocks of a grid superimposed over the image, and based at least in part on a weight applied to each block of the grid to emphasize ad insertion positions on sides and in corners of the grid; and
re-ranking advertisements based at least in part on visual similarity of each advertisement and each of the candidate advertisement insertion positions.

7. One or more computer-readable media as recited in claim 1, wherein suggesting the plurality of regions of interest within the image comprises:
generating a saliency map for the image; and
extracting attended areas or objects from the saliency map.

8. One or more computer-readable media as recited in claim 1, wherein receiving positive or negative input from each user of the pair of users indicating whether each of the plurality of advertisements positively associates with the image comprises a repetitive process wherein a plurality of images are displayed until the pair of users agrees that a displayed image is associated with an advertisement of interest.

9. One or more computer-readable media as recited in claim 1, wherein suggesting the plurality of regions of interest within the image comprises:
generating a saliency map for the image;
extracting attended areas or objects from the saliency map; and
supplementing extracted attended areas with input derived from a facial recognition algorithm applied to the image.

10. One or more computer-readable media as recited in claim 1, additionally comprising annotating the image with a commonly selected advertisement located in a commonly selected region of interest.

11. A method of image selection and region of interest analysis, comprising:
storing, in a memory communicatively coupled to a processor, computer-executable instructions for performing the method;
executing the instructions on the processor;
according to the instructions being executed:
configuring a pair of two or more users, each of the pair located in a distinct location on a network;
displaying an image to at least one user of the pair;
suggesting a plurality of advertisements to accompany the image;
receiving positive or negative input from each user of the pair indicating whether each of the plurality of advertisements positively associates with the image;
suggesting a plurality of regions of interest within the image, the suggesting comprising:
mapping each pixel in the image to express contrast information, the contrast information based at least in part on a neighborhood about the pixel;
extracting at least one attended object from the contrast information, wherein the extraction converts gray-levels of the contrast information to define attended areas and unattended areas;
framing the at least one attended object as an attended view, an attended area or an attended point; and
receiving positive or negative input from each user of the pair indicating whether each of the plurality of regions of interest is appropriately suggested for placement of an advertisement.

12. The method of claim 11, wherein displaying an image to the pair comprises:
obtaining a web page;
segmenting the web page into multiple blocks, wherein the multiple blocks are formed in part by grouping text having consistencies; and
selecting the image from one of the multiple blocks.

13. The method of claim 11, wherein suggesting a plurality of advertisements comprises:
ranking advertisements according to global and local textual relevance between the advertisements and content of the web page;
identifying candidate advertisement insertion positions based at least in part on an average of normalized energies of pixels within blocks of a grid superimposed over the image, and based at least in part on a weight applied to each block of the grid to emphasize ad insertion positions on sides and in corners of the grid; and
re-ranking advertisements based at least in part on visual similarity of each advertisement and each of the candidate advertisement insertion positions.

14. The method of claim 11, wherein receiving positive or negative input from each user of the pair indicating whether each of the plurality of advertisements positively associates with the image comprises a repetitive process wherein a plurality of images are displayed until the pair agrees that a displayed image is associated with an advertisement of interest.

15. The method of claim 11, wherein mapping each pixel in the image to express contrast information comprises:
mapping each pixel in the image to express contrast of that pixel in part according to C_{i,j}=Σ_{qεθ}d(p_{i,j}, q), wherein the C_{i,j} are contrast of pixels p_{i,j} normalized as [0, 255] in an M×N array of pixels representing the image, points q are in a neighborhood θ about p_{i,j}, wherein size of θ can be used to regulate sensitivity of the contrast information, and d is a Gaussian distance function.

16. The method of claim 11, additionally comprising annotating the image to indicate suggested regions of interest for which each user of the pair of users gave positive input.

17. One or more computer-readable media storing computer-executable instructions that, when executed, cause one or more processors to perform acts comprising:
configuring a pair of two or more users to allow comparison of input from the users;
displaying an image to the pair;
suggesting a plurality of advertisements to accompany the image, the suggesting comprising:
ranking advertisements according to global and local textual relevance between the advertisements and content of the web page;
identifying candidate advertisement insertion positions based at least in part on an average of normalized energies of pixels within blocks of a grid superimposed over the image, and based at least in part on a weight applied to each block of the grid to emphasize ad insertion positions on sides and in corners of the grid; and
re-ranking advertisements based at least in part on visual similarity of each advertisement and each of the candidate advertisement insertion positions;
receiving positive or negative input from each user of the pair indicating whether each of the plurality of advertisements positively associates with the image;
suggesting a plurality of regions of interest within the image; and
receiving positive or negative input from each user of the pair indicating whether each of the plurality of regions of interest is appropriately suggested for placement of an advertisement.

18. One or more computer-readable media as recited in claim 17, wherein configuring the pair of users comprises pairing a new user for input comparison to a composite of past users.

19. One or more computer-readable media as recited in claim 17, wherein displaying an image to the pair comprises:
obtaining a web page;
segmenting the web page into multiple blocks, wherein the multiple blocks are formed in part by grouping text having consistencies; and
selecting the image from one of the multiple blocks.

20. One or more computer-readable media as recited in claim 17, wherein suggesting the plurality of regions of interest within the image comprises:
generating a saliency map for the image;
extracting attended areas or objects from the saliency map; and
supplementing extracted attended areas with input derived from facial recognition.
